(19) United States
(12) Patent Application Publication
(10) Pub. No.: US 2023/0297145 A1
(43) Pub. Date: Sep. 21, 2023

(54) Laptop Computer with Flatbed Scanner

(71) Applicant: Charles Randolph Olling, Huntsville, AL (US)

(72) Inventor: Charles Randolph Olling, Huntsville, AL (US)

(21) Appl. No.: 17/695,074

(22) Filed: Mar. 15, 2022

(51) Int. Cl. G06F 1/16

(52) U.S. Cl. CPC G06F 1/1696; G06F 1/1637

(57) ABSTRACT

The laptop computer with flatbed scanner is described from 3 modifications of hardware parts of the laptop computer monitor screen to allow the use of the laptop computer as a flatbed scanner to scan documents and images. This invention allows owners of laptop computers to have the opportunity to conveniently use the laptop computer as a flatbed scanner for documents and images without the need of purchasing and using a separate flatbed scanner.

### BACKGROUND OF THE INVENTION

This invention relates to the use of a laptop computer as a flatbed scanner.

It is one of the objects of this invention to specify the 3 modifications of hardware parts of the laptop computer monitor screen in order to allow the convenient use of the laptop computer as a flatbed scanner to scan documents and images.

1. Previous Laptop Computer Technology

The previous laptop computer technology is described at:

en.wikipedia.org/wiki/Laptop

A laptop computer is a small, easily transportable computer usually with two lids that fold on a hinge with a computer monitor on the inside of the upper lid and a keyboard on the inside of the lower lid. It has ports such for cable connections to separate electronic devices such as a separate flatbed scanner.

The computer monitor is described at:

en.wikipedia.org/wiki/Computer_monitor

The laptop computer monitor is an output device on the inside of the upper lid that displays characters, symbols and images and computer graphics. The laptop computer monitor has a display screen. The screen is typically a thin-film transistor (TFT) liquid crystal display (LCD) panel with backlight source such as a light-emitting diode (LED).

The TFT-LCD display is described at:

en.wikipedia.org/wiki/Thin-film-transistor_liquid-crystal_display

The TFT-LCD display in the computer screen is composed of several layers between two glass substrates arranged in an array of very small pixels.

Each pixel has a thin-film transistor to switch on or off the electric current to the pixel. The thin-film transistor is a transistor made from a thin film of amorphous silicon deposited on a transparent glass substrate.

The thin-film transistor is described at:

en.wikipedia.org/wiki/Thin-film_transistor

The thin-film transistor occupies a small area in the corner of a pixel. The rest of the pixel area has no thin film and light can travel through it.

Each pixel also has a layer of liquid-crystal molecules between two transparent electrodes to form the liquid-crystal display. The LCD is described at:

en.wikipedia.org/wiki/Liquid-crystal_display

The liquid crystals are described at:

en.wikipedia.org/wiki/Liquid_crystal

The transparency in the LCD in each pixel is controlled by the light-modulating properties of liquid crystals along with polarizing filters on the upper and lower faces of the display. The LCD is controlled by electric voltage supplied by the TFT.

The TFT-LCD display blocks or filters the backlight in order to display the desired characters, letters, symbols or image on the laptop computer screen.

LED backlighting is described at:

en.wikipedia.org/wiki/LED-backlit_LCD

In the LED-backlit LCD an LED is used to backlight the liquid-crystal display.

2. Previous Flatbed Scanner Technology

The previous flatbed scanner technology used in a separate device in conjunction with a laptop computer is described at:

en.wikipedia.org/wiki/image_scanner

A flatbed scanner is an electronic hardware device that optically scans documents or images placed on a flat transparent surface and generates an electronic file of the document or image. Flatbed scanners are a commonly used when scanning pages from books or typical letter-size documents or images. Previously typically a separate flatbed scanner has been connected with a cable to a laptop computer. The document or image to be scanned is put on the transparent surface of the flatbed scanner and is scanned to generate the electronic file of the document or image, which is then saved on the laptop computer. Flatbed scanners commonly utilize an image sensor based on a charge-coupled device (CCD) or contact image sensor (CIS). The charge-coupled device is described at:

en.wikipedia.org/wiki/Charge-coupled_device

The contact image sensor is described at:

en.wikipedia.org/wiki/Contact_image_sensor

In the flatbed scanner, bright white light is typically shined on the document or image, which is reflected to the image sensor, which reads the light intensity and color. In the CCD and CIS scanner the light commonly comes from a light-emitting diode (LED) and there are usually rows or arrays of sensors with red, green and blue (RGB) filters which move over the transparent surface to scan the document or image.

A major disadvantage of this previous flatbed scanner technology is that the scanner is not incorporated into the laptop computer and a separate flatbed scanner must be purchased and utilized to scan documents and images.

Previous Electro-Optical Sensor Technology

The Electro-optical sensor or simply optical sensor is described at:

en.wikipedia.org/wiki/Electro-optical_sensor
An electro-optical sensor or optical sensor generates an electric current signal from incident light. Two common types of optical sensors are the phototransistor and the photodiode.

A phototransistor is a transistor that is sensitive to light.

The photodiode is described at:

en.wikipedia.org/wiki/Photodiode

The photodiode is a semiconductor device with a p-n junction that generates an electric current signal from light incident on it. The p-n junction is described at:

en.wikipedia.org/wiki/P-n_junction

### SUMMARY OF THE INVENTION

The laptop computer with flatbed scanner to scan documents and images is manufactured with 3 modifications of hardware parts of a laptop computer monitor screen in the scan area. The 3 modifications of hardware parts involve 1) the backlight source of the pixels in the scan area, 2) the LCD in the pixels and 3) modification of the TFT-LCD to include a thin-film transistor with an optical sensor in the pixels.

The backlight source of the pixels in the scan area is modified to allow a flash of bright white light from the laptop screen directed normal to the screen towards the document or image to be scanned. The LCD in each pixel in the scan area is modified to allow it to be transparent to this flash of bright white flash. The thin-film transistor liquid crystal display (TFT-LCD) is modified to include a thin-film transistor with an optical sensor in the pixels in the scan area to convert the intensity and color of the light reflected from the scanned document into an electric signal. The electric signal is sent to the TFT-LCD in the pixels to display the scanned information on the laptop computer monitor screen for the user to view and save in an electronic file.

### BRIEF DESCRIPTION OF THE DRAWINGS

FIG. 1 is a schematic diagram showing a top view of the laptop computer monitor screen including the scan area of the flatbed scanner for scanning documents or images.

FIG. 2 is a schematic diagram showing a top view of a portion of the scan area of the laptop computer monitor screen with 4 pixels.

FIG. 3 is a schematic diagram showing a side view of the light path and hardware parts of the pixel in the scan area of the laptop computer monitor screen during scanning of a document or image.

### DETAILED DESCRIPTION OF THE INVENTION

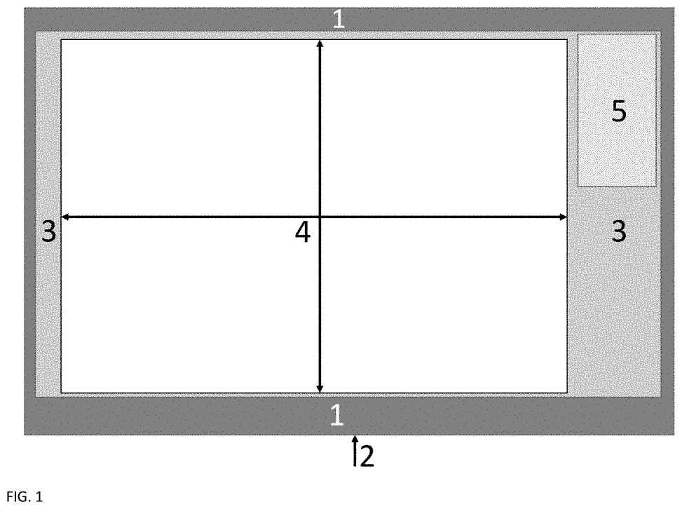

The invention of the laptop computer with flatbed scanner allows the laptop computer to be used as a flatbed scanner to scan documents and images. The laptop computer has a computer monitor screen on the inside of the upper lid which is rotatable to the horizontal position with the laptop computer monitor screen face up so that the document or image to be scanned can be placed face down on the scan area of the laptop computer monitor screen. FIG. 1 shows a schematic diagram of the top view of the laptop computer upper lid (1) rotated about the hinge line (2) at the bottom edge of the upper lid to the horizontal position with the monitor screen (3), scan area (4) for placing facedown the document or image to be scanned, and the scan command window (5) for entering scan options and commands, such as start and save.

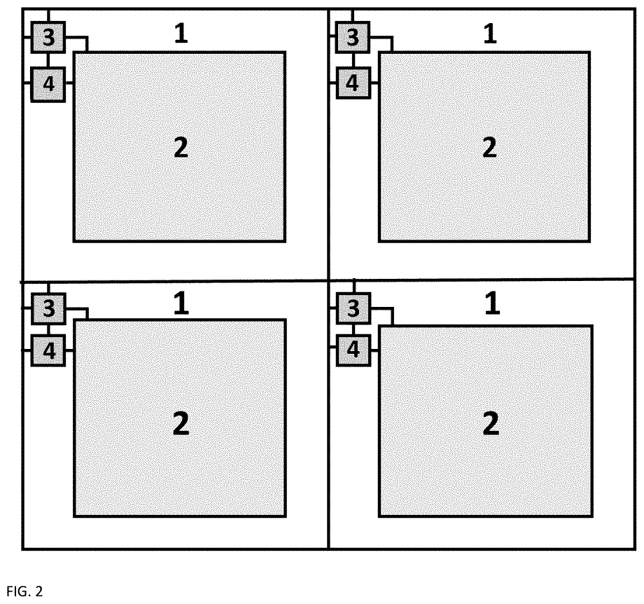

The laptop computer with flatbed scanner is manufactured with 3 modifications of the hardware parts in the pixels of the scan area of the laptop computer monitor screen. FIG. 2 shows a schematic diagram of the top view of 4 pixels in the scan area with pixel (1), LCD (2), TFT (3) for the LCD, and TFT with optical sensor (4).

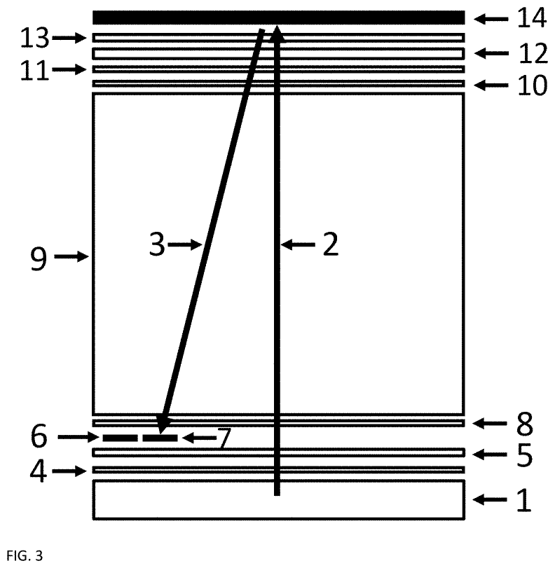

FIG. 3 shows a schematic diagram of a side view through a pixel in the scan area of the laptop computer monitor scheme with the backlight source (1) for a flash of backlight during scanning, the light path of the backlight (2) emitted away from the backlight source, the light path of the reflected light (3) from the document or image to be scanned, the lower polarizer filter (4) next to the backlight source, the lower glass substrate (5), the thin-film transistor (TFT) for the LCD (6), the TFT with the optical sensor (7), the pixel (8) with lower electrode, the liquid crystal display (LCD) (9) above the pixel, the upper electrode (10) above the LCD, the RGB color filter (11), the upper glass substrate (12), the upper polarizer filter (13) and the document or image (14) to be scanned.

The first modification of the hardware of the laptop computer monitor screen involves the backlight source in each pixel of the scan area of the laptop computer screen to allow it to emit a flash of bright white backlight during scanning as shown in FIG. 3 in addition to the normal steady backlight when not scanning.

The second modification of the hardware of the laptop computer monitor screen involves modification of the liquid crystal display (LCD) in each pixel of the scan area to allow it to be completely transparent during the scanning steps of: 1) emission of the bright flash of white backlight at the start of scanning which passes through the transparent LCD of the pixel without any distortion or refraction in the direction normal to the computer screen towards the document or image to be scanned, 2) reflection of the flash of backlight from the document or image to be scanned, and 3) detection of the reflected light by the thin-film transistor with optical sensor. Afterwards the LCD returns to its normal state.

The third hardware modification of the hardware of the computer screen involves the inclusion of a TFT with an optical sensor such as a phototransistor or photodiode in each pixel of the scan area of the laptop computer screen. This TFT with an optical sensor is in addition to the usual TFT operating the LCD of the pixel. This TFT with an optical sensor detects of the intensity and color of the reflected light from the document or image to be scanned and converts it into an electric signal. That electric signal is then sent to the TFT-LCD in the pixels to display the scanned information on the laptop computer monitor screen for the user to view and save in an electronic file.

The typical steps for operation on the laptop computer as a flatbed scanner are as follows. 1) The flatbed scanning software is selected from the list of laptop computer applications, which opens a flatbed scanning command window outside the scan area of the computer screen. 2) The appropriate scanning options are selected, such as size, resolution, black/white, color, automatic detection. 3) The laptop computer screen is rotated to lie horizontal. 4) The document or image to be scanned is placed face down in the scan area of the laptop computer screen. 5) Before the scanning starts the normal backlight of the screen display in the scan area is turned off and the LCD in the pixels of the scan area is made transparent. 6) When the scanning starts a flash of white light backlight occurs in the scan area of the computer screen directed towards the document or image to be scanned. 7) The flash of light passes though the transparent LCD and reflects off the document to be scanned back towards the scan area of the computer screen. 8) The TFT with optical sensor in each pixel of the scan area detects the reflected light and converts the light intensity and color into an electric signal. 9) The normal backlight of the laptop computer screen is restored in the scan area and the electric signal from the TFT with optical sensor is used to activate the TFT-LCD in each pixel of the scan area to show a display of the scanned document or image for the user to view. 10) If the scan display is acceptable, the scanned document or image is saved as an electronic file in a digital format such as .pdf or .png. 11) If the scan display is not acceptable, the scan of the document or image can be repeated or other scan options selected to improve the scan. 12) The next document or image to be scanned is selected and steps 4-11 are repeated.

The description of this invention of the method of the laptop computer with flatbed scanner has not been previously publicly disclosed or available to the public. The invention of this useful method will allow owners of laptop computers to have the opportunity to conveniently use the laptop computer as a flatbed scanner for documents and images without the need of purchasing and using a separate flatbed scanner.

A specific form of the invention of the method of the use of the laptop computer as a flatbed scanner has been described, but it is understood that different variations and modifications of it are still covered by the spirit of the invention or the scope of the following claims.

I claim:

1. A method of manufacture of a laptop computer for use as a flatbed scanner for documents or images, with the device herein termed the laptop computer with flatbed scanner, comprising:
providing a laptop computer with a computer monitor screen on the upper lid which is rotatable to the horizontal position with the laptop computer monitor screen face up so that the document or image to be scanned can be placed face down on the scan area of the laptop computer monitor screen;
providing a laptop computer with a computer monitor screen with hardware parts comprising a backlight source and thin-film transistor (TFT) with liquid crystal display (LCD) in each pixel, the combination termed the TFT-LCD;
providing 3 modifications of the hardware parts in the scan area comprising:
modification of the backlight source in the scan area in the laptop computer screen to allow it to emit a bright flash of white backlight during scanning in addition to the normal steady backlight when not scanning;
modification of the liquid crystal display (LCD) in each pixel of the scan area to allow it to be completely transparent during the scanning steps comprising:
Emission of the bright flash of white backlight at the start of scanning which passes through the transparent LCD of the pixel without any distortion or refraction in the direction normal to the computer screen towards the document or image to be scanned;
Reflection of the flash of backlight from the document or image to be scanned;
Detection of the reflected light by the thin-film transistor with optical sensor;
Afterwards the LCD returns to its normal state;
modification of the TFT-LCD to include a small thin-film transistor with optical sensor such as a phototransistor or photodiode in each pixel of the scan area of the laptop computer screen, in addition to the usual TFT operating the LCD of the pixel, that detects the intensity and color of the reflection of the bright flash of backlight from the document or image to be scanned and converts it into an electric signal which is then sent to the TFT-LCD in the pixels to display the scanned information on the laptop computer monitor screen for the user to view and save in an electronic file;

2. An article of manufacture of said laptop computer with flatbed scanner, produced by the method of manufacture with the modifications of claim 1.
